(19) United States
(12) Patent Application Publication
(10) Pub. No.: US 2013/0300751 A1
(43) Pub. Date: Nov. 14, 2013

(54) METHOD FOR GENERATING MOTION SYNTHESIS DATA AND DEVICE FOR GENERATING MOTION SYNTHESIS DATA

(71) Applicants: Jun Teng, Beijing (CN); Zhijin Xia, Beijing (CN); Kangying Cai, Beijing (CN); Jiheng Yang, Beijing (CN)

(72) Inventors: Jun Teng, Beijing (CN); Zhijin Xia, Beijing (CN); Kangying Cai, Beijing (CN); Jiheng Yang, Beijing (CN)

(73) Assignee: Thomson Licensing, Issy de Moulineaux (FR)

(21) Appl. No.: 13/976,608

(22) PCT Filed: Dec. 29, 2010
(86) PCT No.: PCT/CN2010/002194

§ 371 Date: Jun. 27, 2013

(51) Int. Cl. G06T 13/40

(52) U.S. Cl. CPC G06T 13/40
USPC 345/474; 345/475

(57) ABSTRACT

A method for generating motion synthesis data from two recorded motion clips comprises transforming the motion frames to standard coordinates, separating HF motion data of the motion frames from LF motion data, determining from different motion clips at least two motion frames whose frame distance is below a threshold, and defining a transition point between the at least two motion frames, interpolating motion data between said determined motion frames separately for HF and LF motion data, and generating a motion path from three segments: one segment is transformed motion data from a first motion clip up to the transition point, one segment is the interpolated motion data, and one segment is transformed motion data from a second motion clip, starting from the transition point.

### FIELD OF THE INVENTION

This invention relates to a method for generating motion synthesis data and a device for generating motion synthesis data.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Animated humans are an important part of a diverse range of media, and they are commonplace in entertainment, training, visualization and other applications. Human motion is difficult to animate convincingly, mainly for two reasons: the motion itself is intrinsically complicated, and human observers are very sensitive for errors since they are familiar with natural human motion.

The methods for generating human motions for animating characters can be classified into 3 categories: Keyframing, Physical simulation and Motion capture. In Keyframing animation methods, a sequence of character poses are specified manually. This kind of methods requires an investment of time and artistic talent that is prohibitive for most applications. Also Physical laws can be used to model and simulate human motion: this kind of approaches is physically plausible, but subtle “personality” is hard to reproduce. Finally, motion capture based approaches are more popular: this kind of methods records the motion of a live character, and then plays the animation faithfully and accurate. Motion capture data can be used to create high-fidelity animations of effectively any motion that a real person can perform, and it has become a standard tool in the movie and video game industries.

However, because motion capture data can only reproduce what has been recorded, it provides little control over an animated character's actions. Data-driven motion synthesis methods are used to generate novel motions based on existing motion capture data. Motion graphs based methods are a set of methods that can synthesize novel motions from motion capture database. FIG. 1 illustrates the principle idea of motion graphs. In FIG. 1, nodes 1, . . . , 8 represent short motion clips, and directed edges between the nodes indicate the transition information between motion clips. Novel motions are synthesized from motion graphs using the “depth first search” algorithm according to optimization rules.

Motion transition between different motion clips happens only on similar poses. As shown in FIG. 3, between different kinds of motion clips, e.g. walking and sneaking, only similar poses (marked-up) can be used as transition points. Similar poses are usually found automatically by motion sequence matching algorithms that are similar to image matching algorithms. A similarity metric is calculated between one frame in motion clip A and another frame in motion clip B. The frames with a metric below a threshold can be used as transition poses. In FIG. 4, for the calculation of the metric between a frame [i] in motion clip A and a frame [j] in motion clip B, neighbourhood frames can also be considered in the computation for helping to preserve the dynamics of motions. Analysis of the motion is performed e.g. by using virtual markers that are attached to each joint, as shown in FIG. 5. The positions of the markers can be used in similarity metric computation; the metric can be calculated according to

$${min}_{θ , {X}_{0} , {Z}_{0}} {\sum }_{i} {w}_{i} ‖ {P}_{i} - {T}_{θ , {X}_{0} , {Z}_{0}} {P}_{i}^{′} ‖ \qquad ( 1 )$$

where wᵢ are weights for each joint of the character, T_{θ,X}₀,Z₀ is the optimal transformation that can align motion clip A at frame [i] and motion clip B at frame [j], Pᵢ and Pᵢ′ are marker positions in motion clip A and motion clip B respectively. In literatureⁱ, a different approach for calculating metric is used:

D_{i,j}=d(pᵢ,pⱼ)+vd(v_{i,v}_{ⱼ}) (2)

where d(pᵢ,pⱼ) describes the weighted differences of joint angles, and vd(v_{i,v}_{ⱼ}) represents the weighted differences of joint velocities.

However, known methods can generate transition points only between similar motion segments with respect to Euclidean transformation. Therefore, the following situations are considered as “failure cases” by using previous methods.

First, it is a problem if there are similar motion segments in motion clips, but the timing of these two sequences is different. For example, a walking animation with large steps and one with small steps will be considered as “not similar” when using known metric computation methods. Fast walking and slow walking are also considered as “not similar”.

Second, the known methods can identify only ground based animations: when a character e.g. climbs a ladder, this motion clip will be considered as “not similar” when compared to motions that has movement on the ground.

Third, the motion graphs generated by known methods are “static”; that is, the traversal of motion graphs always generates the same motion path with respect to Euclidean transformation. Thus, a traversal of motion graphs looks unnatural with known methods.

### SUMMARY OF THE INVENTION

It is an object of the present invention to solve at least some of the above-mentioned problems.

The present invention introduces a new motion synthesis system that incorporates a new similarity frame distance metric and a new motion warping algorithm. It can generate transition points between similar motion frames while not being sensitive to “timing” and “on ground” constrains. Further, it provides “dynamic motion graphs” that can be used for obstacle avoidance purpose.

According to the invention, a method for generating motion synthesis data from at least two recorded motion clips comprises steps of

transforming the motion frames to standard coordinates (for substantially each frame of the motion clips),
separating high-frequency motion data of the motion frames from low-frequency motion data of the motion frames,
determining, from different motion clips of said at least two recorded motion clips, at least two motion frames whose frame distance is below a threshold, and defining a transition point between the at least two motion frames,
interpolating motion data between said determined at least two motion frames (wherein the high-frequency motion data and the low-frequency motion data are separately interpolated), and generating a motion path from three segments. In the step of generating a motion path, a first segment is transformed motion data from a first of said different motion clips, up to the transition point, a second segment is the interpolated motion data and a third segment is transformed motion data from a second of said different motion clips, starting from the transition point.

Further, according to another aspect of the invention, a device for generating motion synthesis data from at least two recorded motion clips comprises

transform means for transforming the motion frames to standard coordinates for each frame of the motion clips,
separating means for separating high-frequency motion data of the motion frames from low-frequency motion data of the motion frames,
determining means for determining from different motion clips of said at least two recorded motion clips at least two motion frames whose frame distance is below a threshold, and for defining a transition point between the at least two motion frames,
interpolating means for interpolating motion data between said determined at least two motion frames, wherein the high-frequency motion data and the low-frequency data are separately interpolated, and
motion path synthesis means for generating a motion path from three segments, wherein a first segment is transformed motion data from a first of said different motion clips, up to the transition point, a second segment is the interpolated motion data and a third segment is transformed motion data from a second of said different motion clips, starting from the transition point.

Advantageous embodiments of the invention are disclosed in the dependent claims, the following description and the figures.

### BRIEF DESCRIPTION OF THE DRAWINGS

Exemplary embodiments of the invention are described with reference to the accompanying drawings, which show in

FIG. 1 an exemplary motion graph;

FIG. 2 a flow-chart of various embodiments of a method for generating motion synthesis data according to the invention;

FIG. 3 two different kinds of motion;

FIG. 4 a match window for two sets of motion clips;

FIG. 5 virtual markers for metric computation;

FIG. 6 exemplary path fitting and obstacle avoidance;

FIG. 7 an exemplary organization of joints in a hierarchical structure;

FIG. 8 a block diagram of a motion synthesis system according to one embodiment;

FIG. 9 motion transition between motion graphs;

FIG. 10 transformation of motion frames to standard coordinates for metric computation;

FIG. 11 details of the motion signal transformation block;

FIG. 12 results of a frequency analysis of a rotation around the y-axis;

FIG. 13 exemplary motion path warping applied to a character; and

FIG. 14 modules of a device for generating motion synthesis data.

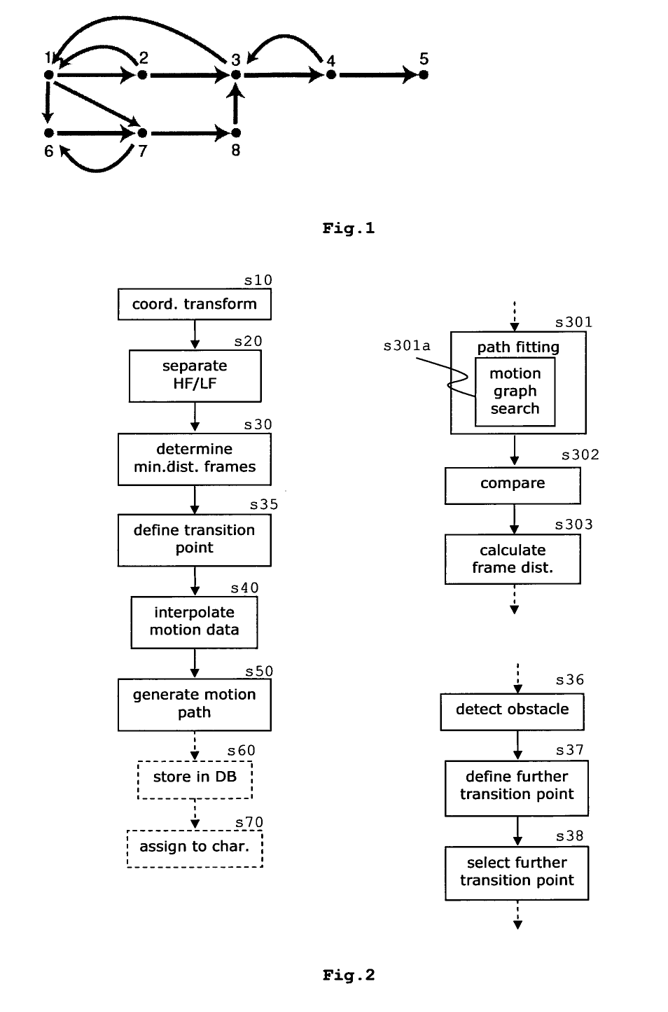

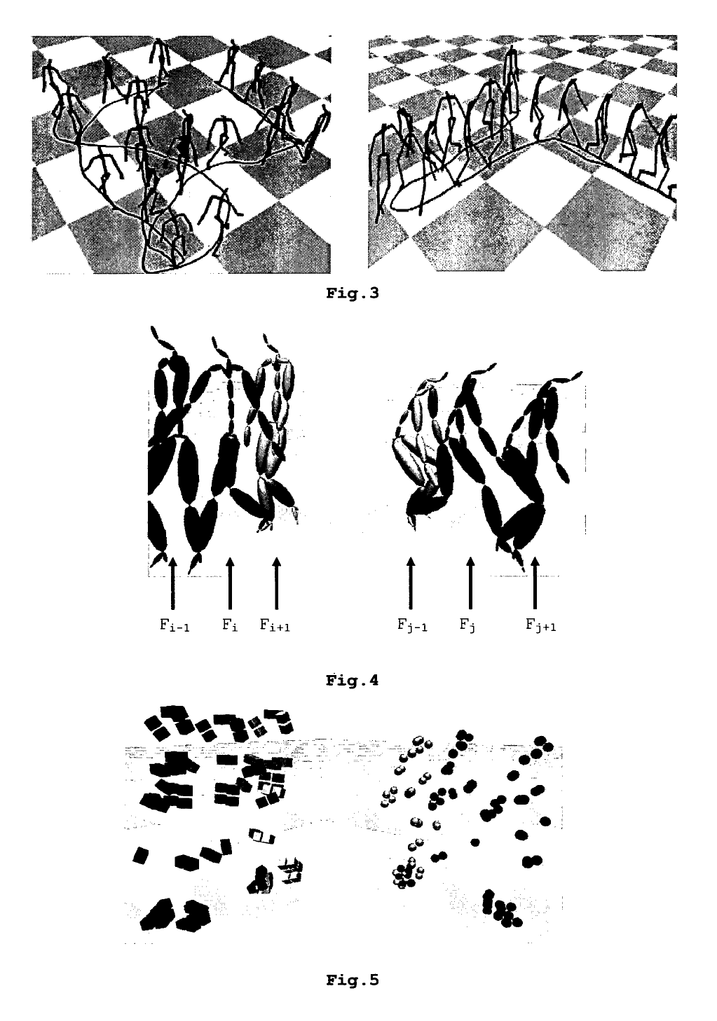

### DETAILED DESCRIPTION OF THE INVENTION

This invention proposes a novel motion synthesis system, which uses a new metric that can measure the difference between two frames in different motion clips, regardless of the local coordinate frame of the motions.

A flow-chart of a method for generating motion synthesis data from at least two recorded motion clips is shown in FIG. 2, and is described further below.

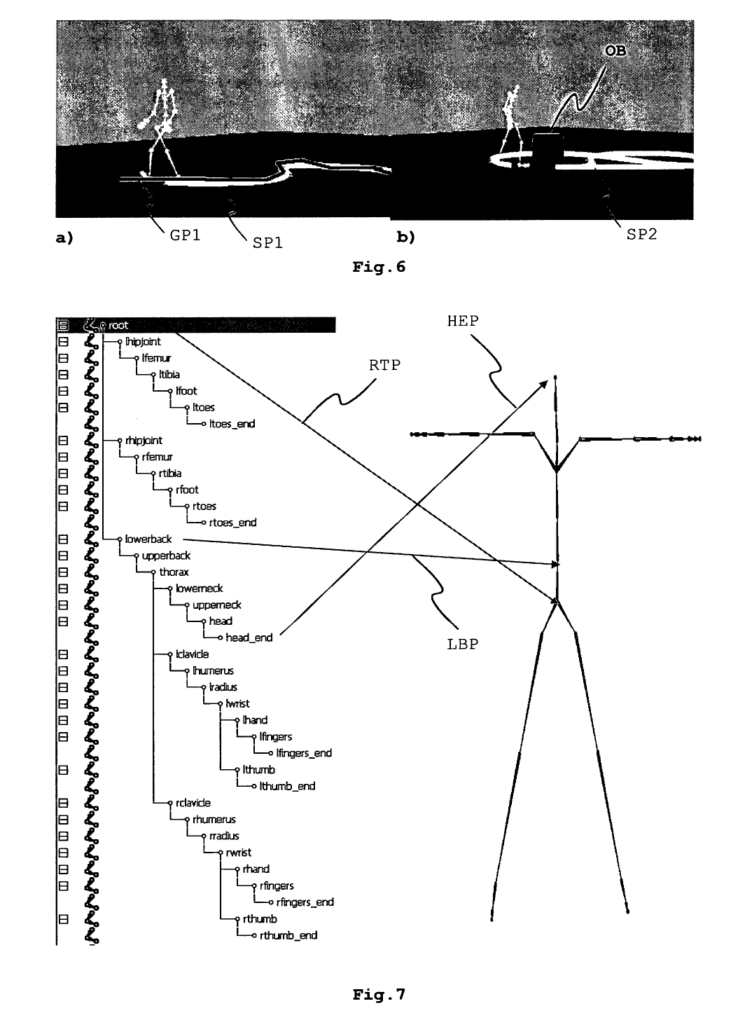

The motion graphs generated by the system can be used for path fitting purpose as well as obstacle objects avoidance. FIG. 6 shows exemplary applications of the invention. In Path fitting (FIG. 6 a), a system according to the invention searches for a given path GP the motion graphs and generates synthetic motion by concatenating motion segment nodes to fit the path SP1. In Obstacle objects avoidance (b), when a synthetic motion is generated, and an obstacle OB appeared in the way, then the system can automatically calculate a synthesized path SP2 that avoids this obstacle, without having to re-search the motion graph.

In a motion capture clip, the data is organized in a hierarchical way, as shown in FIG. 7: there is one root joint (or junction), and all the other joints are children and grandchildren of this joint. For example, the root joint represents RTP the center of the character, a head-end joint represents HEP the head-end point of the character, and a lower back joint represents LBP the lower back of the character. The root joint is translated and rotated to take the character to a new position and/or orientation in each frame. Each transformation RTP,HEP,LBP of any parent joint is propagated to its children and further propagated to its grandchildren. For example, if an arm moves, also the hand and all its fingers move.

One aspect of this invention is a root-irrelevant motion segment clips matching algorithm, and a motion path warping algorithm that may be based on B-spline wavelets or other, comparable methods.

In the following, the root-irrelevent motion segment clips matching algorithm is described. Each frame in two or more motion clips is transformed to standard coordinates. That is, the root's translation and rotation are compensated and can be ignored. If a set of frames in one motion clip matches another set of frames in another motion clip, these two sets are considered as “similar” in standard coordinates. Any coordinate system can be defined as standard coordinates, as long as the definition is maintained for all involved motion clips. For generating transition frames between frames in different motion clips, the below-described motion path warping algorithm is used.

For the motion path warping, in one embodiment a B-spline wavelet transform to the motion signals of the root joint is applied. The high-frequency (HF) and low-frequency (LF) coefficients of the transformation results are treated separately, and are considered as “motion path” (LF coefficients) and “motion detail” (HF coefficients) for the root joint. The NURBS (Non-Uniform Rational B-Spline) curve reconstructed from low-frequency coefficients in one motion clip is morphed to another NURBS curve that represents the “motion path” in another motion clip. After the morphing operation, the “motion detail” (high frequency coefficients) is added to generate the final animation clip.

The present invention separates the transformation of the root joint from motion clip data. Thus, when a continuous set of frames in one motion clip is similar to a continuous set of frames in another clip, then these two sets of frames are considered as “similar”, regardless of the timing scale between these two motions.

In one embodiment, the present invention uses a wavelet based framework for motion path warping. Advantages of this algorithm are as follows: First, transition motion between two motion clips can be generated by this algorithm without losing detailed animation information, which is in the HF motion data. Second, when a searching operation of motion graphs is finished, the character can avoid obstacle objects automatically by morphing motion paths of linked graph nodes. Prior art methods would have to re-search the motion graphs for this purpose, which is difficult since motion graph searching algorithms grow exponentially with the complexity of the graph. The present invention can skip any re-search of the motion graph.

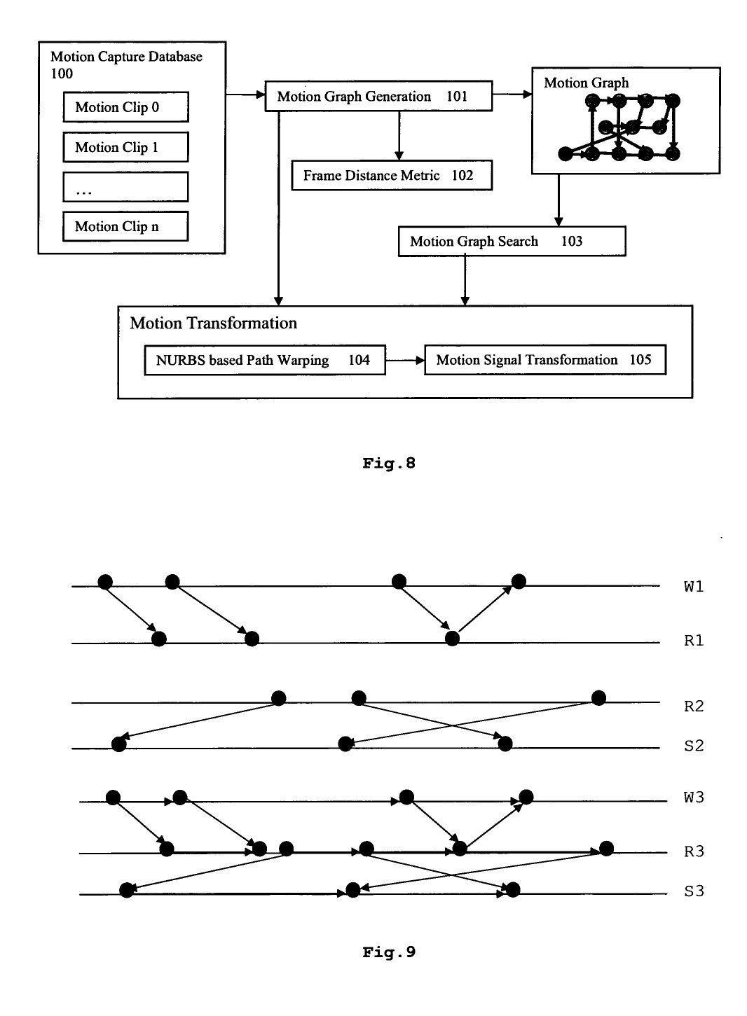

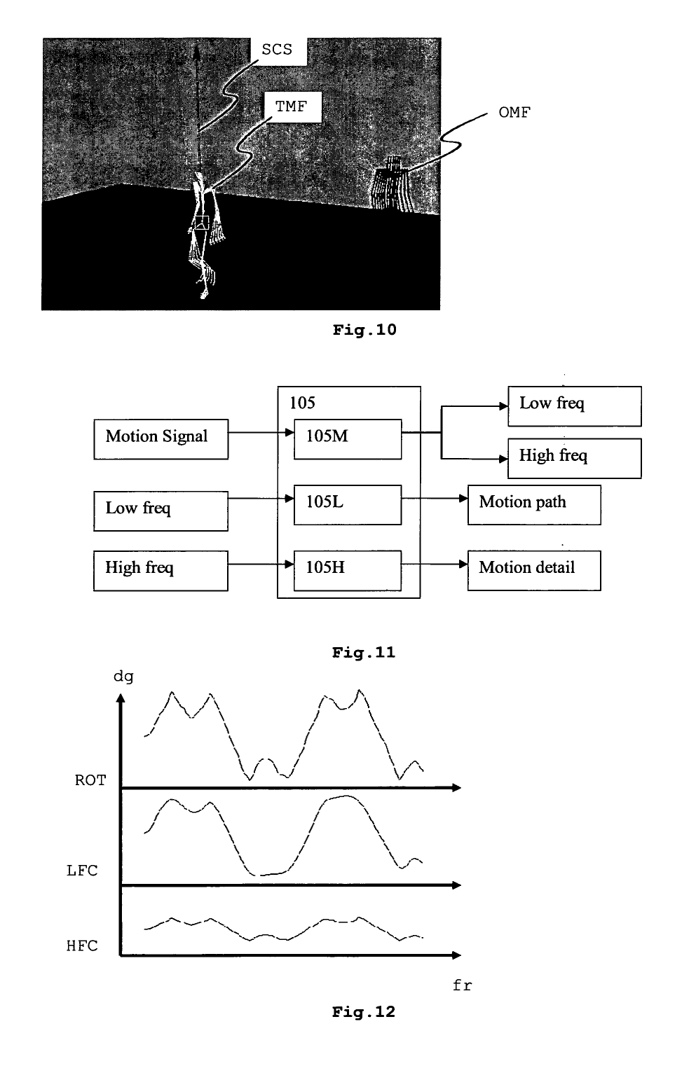

A block-diagram of the proposed motion synthesis system is illustrated in FIG. 8. The input to the system is received from a motion capture database 100, which may contain a large amount of various motion clips (but at least two). The Motion graph generation block 101 performs pair-wise reading of motion clips from the motion capture database 100, lets them be transformed by a motion transformation block and calculates automatically motion transitions between the two resulting clips. In the motion transformation block, the original motion frames OMF are first transformed to a standard coordinate system SCS, as FIG. 10 shows. As a result, transformed motion frames TMF are obtained; that is, the root joint's transformation information is compensated, and can be ignored for the subsequent processing. Then the motion transitions are combined to form the motion graph.

FIG. 9 illustrates the motion graph generation procedure by a simple example, where the motion graph contains three motion clips, while in real applications there are 10-20 motion clips in a motion graph. In the top diagram in FIG. 9, motion transitions are calculated between walk and run motion clips. In the middle diagram, Motion transitions are calculated between run and stride motion clips, and in the bottom diagram two motion transitions are combined to generate a motion graph that contains walk, run and stride motion clips.

Returning to FIG. 8, the Frame distance metric block 102 is used by the motion graph generation block 101 to find similar frames for generating transition points. The metric that this block uses is defined on a frame-to-frame basis according to

$$d ( f , {f}^{′} ) = {\sum }_{i = 1}^{N} {w}_{i} ‖ {P}_{i} - {P}_{i}^{′} ‖ \qquad ( 3 )$$

where Pᵢ and Pᵢ′ are positions of virtual markers attached to joints, N is the total number of markers, and wᵢ are weights for markers. Three markers are attached for each joint, in local x, y and z direction respectively, and all wᵢ are set according to experience, e.g. between 0.5 and 1.5. In experiments, wᵢ were exemplarily set to 1.0. There is a transition point between two motion clips if two sequences of continuous frames in both clips have a metric as defined by equation 3 that is below a specific threshold; that is, if the metric for two frames f and f′ is below a threshold (d(f,f′)<thr), then a transition point is defined between the frames f and f′.

An advantage of this frame-to-frame metric calculation is that it can find more transition points between motion clips, because the timing and path warping factor in motion can be omitted due to the transformation to the standard coordinate frame. Each motion segment is input to a Motion transformation component, which outputs a motion clip that follows a normalized path.

The motion transformation block may comprise a NURBS-based path warping block 104 and a two-way motion signal transformation component block 105, as shown in FIG. 11. The block 105 can transform the motion signal into the frequency domain, so that the low frequency parts can be separated from the high frequency parts. FIG. 12 shows an example for a rotation of the root joint around the Y-axis. In FIG. 12, the ordinate deg shows rotation degrees and the abscissa shows frames fr. It has been found that any recorded natural motion comprises low frequency components LFC and high frequency components HFC. According to the invention, the low frequency parts are used as the motion path, and the high frequency parts HF are used as the motion details. In other words, the low frequency part of the joints' motion signals represent overall movement, and high frequency parts of joints' motion signals encode individual motion details that can be considered as the subtle personality of a character. Both can be separately assigned. As a consequence, the animation of the characters looks more individual and thus more realistic.

For this purpose, the path warping block 104 shown in FIG. 8 transforms the path defined by low frequency signals, as generated by the LF motion signal transformation block 105L, into another path, and then adds high frequency signals as generated by the HF motion signal transformation block 105H to the warped path in order to add “personality” to the final motion.

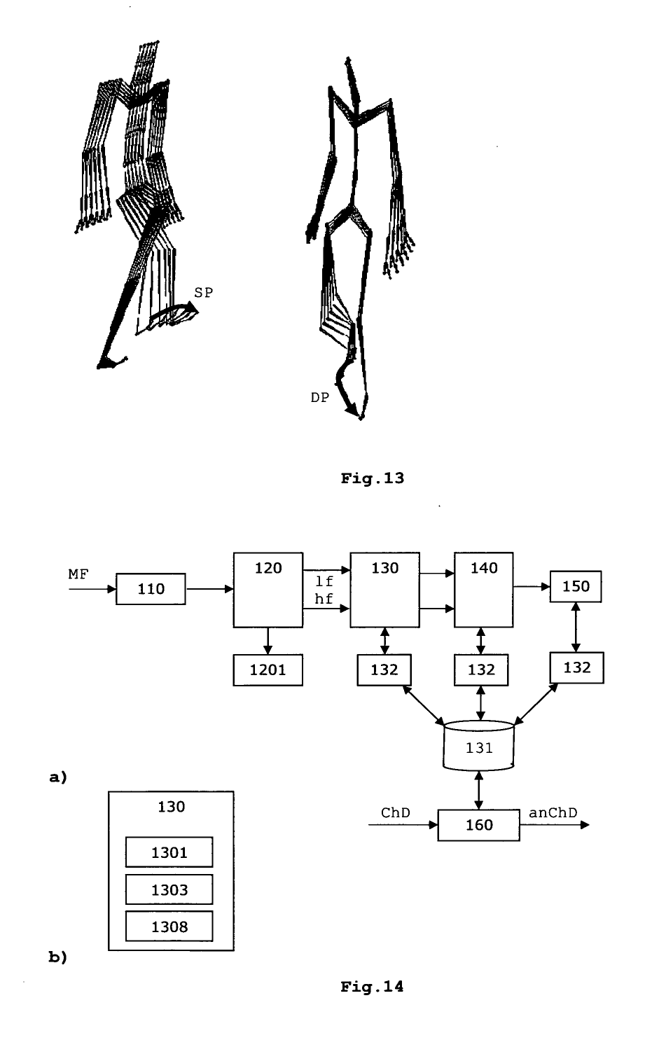

The block 104 in FIG. 8 uses a NURBS curve warping algorithm to transform one path to another path, as illustrated in FIG. 13. The source path SP and destination paths DP are both represented by NURBS curves. The control vertices of a source curve are transformed into control vertices of a destination curve by Euclidean transformation (e.g. in principle linear in space), thus the source curve can be transformed into the destination curve.

FIG. 8 also shows a Motion graph search Block 103. The actual motion graph search algorithm is similar to known methods, e.g. depth search. The path fitting can be achieved by depth search of motion graphs. When an obstacle object appears along the motion path, previously known methods must perform a re-search of the motion graph to avoid obstacle collision. However, the computation complexity is exponential to the number of motion transitions. The proposed system solves the problem by morphing motion paths of adjacent motion graphs nodes, in block 104 and block 105, without re-searching the motion graphs. Advantageously, this method is less time consuming, since the motion graph searching operation needs to be performed only once.

In one aspect, the present invention relates to a motion synthesis system having an integrated motion transition clip computation component that computes frame similarities in a standard coordinate system. In one embodiment, the motion synthesis system has an integrated motion path warping component for obstacle avoidance, using a path warping algorithm to morph the search result of motion graphs.

In one aspect, the invention relates to a method for root-joint-transformation compensated frame matching, which transforms all frames into a standard coordinate space and matches two sets of continuous frames between different motion clips for finding transition points. This scheme can generate transition points regardless of timing constraints. The method may use signal spectrum decomposition and NURBS curves warping algorithms for motion path warping. The system may further synthesize character animation with depth first search of motion graphs, and use the above-described method for obstacle avoidance. The system can generate motion graphs from pairs of motion transition information; the transition information is computed using the above-mentioned method.

The invention can also be applied to other character animation and motion synthesis applications.

In the following, various embodiments are described.

A flow-chart of a method for generating motion synthesis data from at least two recorded motion clips is shown in FIG. 2. In one embodiment, it comprises steps of transforming s10 the motion frames to standard coordinates for each frame of the motion clips, separating s20 high-frequency motion data of the motion frames from low-frequency motion data of the motion frames, determining s30 from different motion clips of said at least two recorded motion clips at least two motion frames whose frame distance is below a threshold, and defining s35 a transition point between the at least two motion frames, interpolating s40 motion data between said determined at least two motion frames, wherein the high-frequency motion data and the low-frequency data are separately interpolated, and generating s50 a motion path from three segments, wherein a first segment is transformed motion data from a first of said different motion clips up to the transition point, a second segment is the interpolated motion data, and a third segment is transformed motion data from a second of said different motion clips, starting from the transition point.

In one embodiment of the method, the interpolating uses B-spline (NURBS) curve warping.

In one embodiment of the method, the determining comprises a step of path fitting s301, wherein motion graph depth search s301a is performed.

In one embodiment of the method, for at least one frame of a first motion clip two or more frames from different second and third motion clips are determined, and at least two transition points are defined s35,s37 for the at least one frame of the first motion clip.

In one embodiment, the method further comprises a step of selecting s38 the other transition point for the at least one frame of the first motion clip upon motion path recalculation, e.g. after a further step of detecting an obstacle object s36.

In one embodiment of the method, the step of separating high-frequency motion data from low-frequency motion data comprises performing frequency analysis on the transformed motion data, or comprises performing frequency analysis on the motion data before said transforming step.

In one embodiment of the method, wavelet transform is used in the step of separating high-frequency motion data from low-frequency motion data.

In one embodiment of the method, the step of determining at least two motion frames whose frame distance is below a threshold s30 comprises a step of calculating s303 a frame distance.

In one embodiment, the method further comprises a step of storing s60 transition point data of said defined transition point in a motion database.

In one embodiment, the method further comprises a step of assigning s70 the motion data of the generated motion path to an animated character.

In one embodiment, a device for generating motion synthesis data from at least two recorded motion clips comprises

transform means 110 (e.g. transformer or processor) for transforming the motion frames to standard coordinates for each frame of the motion clips,
separating means 120 (e.g. separator or filter) for separating high-frequency motion data of the motion frames from low-frequency motion data of the motion frames,
determining means 130 (e.g. discriminator, comparator, or processor) for determining from different motion clips of said at least two recorded motion clips at least two motion frames whose frame distance is below a threshold, and for defining a transition point between the at least two motion frames,
interpolating means 140 (e.g. processor) for interpolating motion data between said determined at least two motion frames, wherein the high-frequency motion data and the low-frequency data are separately interpolated, and
motion path synthesis means 150 (e.g. path synthesizer or processor) for generating a motion path from three segments, wherein a first segment is transformed motion data from a first of said different motion clips, up to the transition point, a second segment is the interpolated motion data and a third segment is transformed motion data from a second of said different motion clips, starting from the transition point.

In one embodiment of the device, the interpolating means 140 performs B-spline (NURBS) curve warping.

In one embodiment of the device, the determining means 130 comprises path fitting means 1301 for performing path fitting wherein the path fitting comprises a motion graph depth search.

In one embodiment, the device further comprises selecting means 1308 for selecting the other transition point for the at least one frame of the first motion clip upon motion path recalculation, e.g. after detecting an obstacle object in an obstacle detection means.

In one embodiment of the device, the separating means 120 for separating high-frequency motion data from low-frequency motion data comprises frequency analysis means 1201 for performing frequency analysis on the transformed motion data, or on the motion data before said transforming.

In one embodiment of the device, the separating means 120 comprises wavelet transform means 1202 for performing a wavelet transform.

In one embodiment, the device further comprises calculation means 1303 for calculating a frame distance.

In one embodiment, the device further comprises memory means 131 and one or more memory control means 132 for generating a motion database and storing the transition point data in a motion database.

In one embodiment, the device further comprises assigning means 160 for assigning the motion data of the generated motion path to character data for obtaining an animated character.

While there has been shown, described, and pointed out fundamental novel features of the present invention as applied to preferred embodiments thereof, it will be understood that various omissions and substitutions and changes in the apparatus and method described, in the form and details of the devices disclosed, and in their operation, may be made by those skilled in the art without departing from the spirit of the present invention. Although the present invention has been disclosed with regard to human motion, one skilled in the art would recognize that the method and devices described herein may be applied to any character motion. It is expressly intended that all combinations of those elements that perform substantially the same function in substantially the same way to achieve the same results are within the scope of the invention. Substitutions of elements from one described embodiment to another are also fully intended and contemplated.

It will be understood that the present invention has been described purely by way of example, and modifications of detail can be made without departing from the scope of the invention. Each feature disclosed in the description and (where appropriate) the claims and drawings may be provided independently or in any appropriate combination. Features may, where appropriate be implemented in hardware, software, or a combination of the two. Reference numerals appearing in the claims are by way of illustration only and shall have no limiting effect on the scope of the claims.

### Annotation

J. Lee, J. Chai, P. Reitsma, J. Hodgins, and N. Pollard: “Interactive control of avatars animated with human motion data”, ACM Transactions on Graphics, 21(3):491-500, 2002

1. A method for generating motion synthesis data from at least two recorded motion clips, comprising steps of
for each frame of the motion clips, transforming the motion frames to standard coordinates;
separating high-frequency motion data of the motion frames from low-frequency motion data of the motion frames;
determining, from different motion clips of said at least two recorded motion clips, at least two motion frames whose frame distance is below a threshold, and defining a transition point between the at least two motion frames;
interpolating motion data between said determined at least two motion frames, wherein the high-frequency motion data and the low frequency motion data are separately interpolated;
generating a motion path from three segments, wherein a first segment is transformed motion data from a first of said different motion clips, up to the transition point, a second segment is the interpolated motion data and a third segment is transformed motion data from a second of said different motion clips, starting from the transition point.

2. The method according to claim 1, wherein the interpolating uses B-spline curve warping.

3. The method according to claim 1, wherein the determining comprises a step of path fitting, wherein motion graph depth search is performed.

4. The method according to claim 1, wherein for at least one frame of a first motion clip two or more frames from different second and third motion clips are determined, and at least two transition points are defined for the at least one frame of the first motion clip.

5. The method according to claim 4, further comprising a step of selecting the other transition point for the at least one frame of the first motion clip upon motion path recalculation.

6. The method according to claim 1, wherein the step of separating, high-frequency motion data from low-frequency motion data comprises performing frequency analysis on the transformed motion data, or on the motion data before said transforming step.

7. The method according to claim 1, wherein wavelet transform is used in the step of separating high-frequency motion data from low-frequency motion data.

8. The method according to claim 1, wherein the step of determining at least two motion frames whose frame distance is below a threshold comprises a step of calculating a frame distance.

9. The method according to claim 1, further comprising a step of storing transition point data of said defined transition point in a motion database.

10. The method according to claim 1, further comprising a step of assigning the motion data of the generated motion path to an animated character.

11. A device for generating motion synthesis data from at least two recorded motion clips, comprising
transform means for transforming the motion frames to standard coordinates for each frame of the motion clips;
separating means for separating high-frequency motion data of the motion frames from low-frequency motion data of the motion frames;
determining means for determining from different motion clips of said at least two recorded motion dips at least two motion frames whose frame distance is below a threshold, and for defining a transition point between the at least two motion frames;
interpolating means for interpolating motion data between said determined at least two motion frames, wherein the high-frequency motion data and the low-frequency data are separately interpolated; and
motion path synthesis means for generating a motion path from three segments, wherein a first segment is transformed motion data from a first of said different motion clips, up to the transition point, a second segment is the interpolated motion data and a third segment is transformed motion data from a second of said different motion clips, starting from the transition point.

12. The device according to claim 11, wherein the determining means comprises path fitting means for performing path fitting wherein the path fitting comprises a motion graph depth search.

13. The device according to claim 11, further comprising selecting means for selecting the other transition point for the at least one frame of the first motion dip upon motion path recalculation.

14. The device according to claim 11, wherein the separating means for separating high-frequency motion data from low-frequency motion data comprises frequency analysis means for performing frequency analysis on the transformed motion data, or on the motion data before said transforming.

15. The device according claim 11, further comprising memory means and memory control means for generating a motion database and storing the transition point data in a motion database.

16. A motion synthesis system having an integrated motion transition clip computation component that computes frame similarities in a standard coordinate system, wherein the integrated motion transition clip computation component has an integrated motion path warping component for obstacle avoidance that uses a path warping algorithm for morphing a result of a motion graph depth search.
